(19) United States
(12) Patent Application Publication
(10) Pub. No.: US 2006/0253739 A1
(43) Pub. Date: Nov. 9, 2006

(54) Method and apparatus for performing unit testing of software modules with use of directed automated random testing

(76) Inventors: Patrice Ismael Godefroid, Naperville, IL (US); Nils Klarlund, Chatham, NJ (US); Koushik Sen, Champaign, IL (US)

Correspondence Address: Lucent Technologies Inc.;Docket Administrator - Room 3J-219, 101 Crawfords Corner Road, Holmdel, NJ, 07733-3030, US

(21) Appl. No.: 11/120,776

(22) Filed: May 3, 2005

(51) Int. Cl. G06F 11/00

(52) U.S. Cl. 714/38

(57) ABSTRACT

A method and apparatus for performing unit testing of software modules uses a novel directed automated random testing approach that advantageously combines automated extraction of the interface of a program with its external environment using static source code parsing; automatic generation of a test driver for this interface that advantageously performs random testing to simulate the most general environment the program can operate in; and dynamic analysis of how the program behaves under random testing and automatic generation of new test inputs to direct systematically the execution along alternative program paths. Together, these techniques constitute a directed automated random testing approach (DART). With DART, testing can be performed completely automatically on any program that compiles without the need to write any test driver or harness code. During testing, DART detects standard errors such as program crashes, assertion violations, and non-termination conditions.

### GOVERNMENT CONTRACT

This invention was made with Government support under Contract CCR-0341658 awarded by NSF. The Government has certain rights in this invention.

### FIELD OF THE INVENTION

The present invention relates generally to the field of software testing and in particular to a method and apparatus for performing unit testing of software modules with use of a novel directed automated random testing approach.

### BACKGROUND OF THE INVENTION

Today, testing is the primary way to check the correctness of software. Billions of dollars are spent on testing in the software industry, as testing usually accounts for about 50% of the cost of software development. For example, it was recently estimated that software failures currently cost the US economy alone about $60 billion every year, and that improvements in software testing infrastructure might save one-third of this cost.

Among the various kinds of testing usually performed during the software development cycle, unit testing applies to the individual components of a software system. In principle, unit testing plays an important role in ensuring overall software quality since its role is precisely to detect errors in the component's logic, check all corner cases, and provide complete code coverage. Yet, in practice, unit testing is so hard and expensive to perform that it is rarely done properly. Indeed, in order to be able to execute and test a component in isolation, one needs to write test driver/harness code to simulate the environment of the component. More code is needed to test functional correctness, for instance using assertions checking the component's outputs. Since writing all of this testing code manually is expensive, unit testing is often either performed very poorly or skipped altogether. Moreover, subsequent phases of testing, such as feature, integration and system testing, are meant to test the overall correctness of the entire system viewed as a black-box, not to check the corner cases where bugs causing reliability issues are typically hidden. As a consequence, many software bugs that should have been caught during unit testing remain undetected until field deployment.

### SUMMARY OF THE INVENTION

In accordance with an illustrative embodiment of the present invention, a method and apparatus for performing unit testing of software modules uses a novel directed automated random testing approach that advantageously combines three main techniques—automated extraction of the interface of a program with its external environment using static source code parsing; automatic generation of a test driver for this interface that advantageously performs random testing to simulate the most general environment the program can operate in; and dynamic analysis of how the program behaves under random testing and automatic generation of new test inputs to direct systematically the execution along alternative program paths. Together, these three techniques advantageously constitute a directed automated random testing approach which will be referred to herein as DART for short.

With the use of DART in accordance with the principles of the present invention, testing can be advantageously performed completely automatically on any program that compiles without the need to write any test driver or harness code. Moreover, during testing, DART advantageously detects standard errors such as program crashes, assertion violations, and non-termination conditions. In accordance with one illustrative embodiment of the present invention, DART may be advantageously implemented for programs written in the C programming language.

### BRIEF DESCRIPTION OF THE DRAWINGS

FIG. 1 shows an illustrative “symbolic evaluation” routine for use in accordance with an illustrative embodiment of the present invention.

FIG. 2 shows an illustrative “test driver” routine for use in accordance with an illustrative embodiment of the present invention.

FIG. 3 shows an illustrative “instrumented program” routine for use in accordance with an illustrative embodiment of the present invention.

FIG. 4 shows an illustrative “compare and update stack” routine for use in accordance with an illustrative embodiment of the present invention.

FIG. 5 shows an illustrative “solve path constraint” routine for use in accordance with an illustrative embodiment of the present invention.

FIG. 6 shows an illustrative C code example to be tested with use of the herein described method for performing unit testing of software modules in accordance with an illustrative embodiment of the present invention.

FIG. 7 shows an illustrative test driver generated for the illustrative C code example of FIG. 6 in accordance with an illustrative embodiment of the present invention.

FIG. 8 shows an illustrative procedure for randomly initializing C variables for use in accordance with an illustrative embodiment of the present invention.

### DETAILED DESCRIPTION OF THE ILLUSTRATIVE EMBODIMENT

Consider the function h in the program below:

int f(int x) { return 2 * x; }
int h(int x, int y) {

if (x != y)

if (f(x) == x + 10)

| | |
|---|---|
| abort( ); | /* error */ |

return 0;

}

In the above program, the function h is defective because it may lead to an abort statement for some value of its input vector, which consists of the input parameters x and y. Running the program with random values of x and y is unlikely to discover the bug. The problem is typical of random testing—it is difficult to generate input values that will drive the program through all its different execution paths.

In contrast, in accordance with an illustrative embodiment of the present invention, DART is advantageously able to dynamically gather knowledge about the execution of the program in what will be referred to herein as a “directed search.” Starting with a random input, a DART-instrumented program in accordance with an illustrative embodiment of the present invention advantageously calculates, during each execution, an input vector for the next execution. This vector contains values that are the solution of symbolic constraints gathered from predicates in branch statements during the previous execution. The new input vector attempts to force the execution of the program through a new path. By repeating this process, a directed search attempts to force the program to sweep through all its feasible execution paths.

For the illustrative example above, the DART-instrumented h initially “guesses” (e.g., randomly) the value 269167349 for x and 889801541 for y. As a result, h executes the then-branch of the first if-statement, but fails to execute the then-branch of the second if-statement. Thus, no error is encountered. Intertwined with the normal execution, the predicates x₀≠y₀ and 2·x₀≠x₀+10 are formed “on the fly” according to how the conditionals evaluate. Note that x₀ and y₀ are symbolic variables that represent the values of the memory locations of variables x and y. Note also that the expression 2·x₀, representing f(x) is advantageously defined through an interprocedural, dynamic tracing of symbolic expressions.

The predicate sequence <x₀≠y₀, 2·x₀≠x₀+10 >, called a path constraint, represents an equivalence class of input vectors, namely all the input vectors that drive the program through the path that was just executed. To force the program through a different equivalence class, the DART-instrumented h advantageously calculates a solution to the path constraint <x₀≠y₀, 2·x₀≠x₀+10>, which is obtained by negating the last predicate of the current path constraint.

One solution to this path constraint is clearly (x₀=10; y₀=889801541) and, illustratively, it is recorded to a file. Then, when the instrumented h runs again, it advantageously reads the values of the symbolic variables that have been solved from the file. In this case, the second execution then reveals the error by driving the program into the abort ( ) statement as expected.

In accordance with an illustrative embodiment of the present invention, DART advantageously runs the program P under test both concretely, executing the actual program with random inputs, and symbolically, calculating constraints on values at memory locations expressed in terms of input parameters. These “side by side” executions require the program P to be instrumented at the level of a RAM (Random Access Memory) machine. (RAM machines are fully familiar to those of ordinary skill in the art.)

The “memory” M is a mapping from memory addresses m to, for example, 32 bit words. The notation “+” will be used herein for mappings to denote updating—for example, M′:=M+[m [symbol] >v] is the same map as M, except that M′(m)=v. We identify “symbolic variables” by their addresses. Thus in an expression, m denotes either a memory address or the symbolic variable identified by address m, depending on the context. A “symbolic expression,” or just expression, e can be of the form m, c (a constant), *(e′, e″) (a dyadic term denoting multiplication), ≦(e′, e″) (a term denoting comparison), [symbol] (e′) (a monadic term denoting negation), *e′ (a monadic term denoting pointer dereference), etc. Thus, the symbolic variables of an expression e are the set of addresses m that occur in it. Note that expressions have no side effects.

The program P advantageously manipulates the memory through “statements” that are specially tailored abstractions of the machine instructions actually executed. There is a set of numbers that denote instruction addresses, that is, statement labels. If l is the address of a statement (other than abort or halt), then l+1 is guaranteed to also be an address of a statement. The initial address is l₀. A statement can be a “conditional statement” c of the form if (e) then goto l′ (where e is an expression over symbolic variables and l′ is a statement label), an “assignment statement” a of the form m←e (where m is a memory address), abort, corresponding to a program error, or halt, corresponding to normal termination.

The concrete semantics of the RAM machine instructions of P is reflected in evaluate_concrete(e, M), which evaluates expression e in context M and returns a 32 bit value for e. Additionally, the function statement_at(l, M) specifies the next statement to be executed. For an assignment statement, this function calculates, possibly involving address arithmetic, the address m of the left hand side, where the result is to be stored; in particular, indirect addressing, e.g., stemming from pointers, is resolved at runtime to a corresponding absolute address. (Note that this is done to advantageously simplify the exposition; in accordance with other illustrative embodiments of the present invention, a theorem prover more powerful than the integer linear solver used in the illustrative embodiment described herein may be employed, in which case it may be possible to make left hand sides symbolic as well.)

A program P defines a sequence of “input addresses” \vec{M}₀, the addresses of the input parameters of P. An input vector \vec{I}, which associates a value to each input parameter, defines the initial value of \vec{M}₀ and hence M.

Let C be the set of conditional statements and A the set of assignment statements in P. Then, a “program execution” w is a finite sequence in Execs:=(A∪C)*(abort|halt). Note that w may be viewed as being of the form α₁c₁α₂c₂ . . . cₖαₖ₊₁s, where αᵢεA* (for 1≦i≦k+1), cᵢεC (for 1≦i≦k), and sε{abort, halt}.

The concrete semantics of P at the RAM machine level advantageously allows us to define for each input vector \vec{I} an execution sequence: the result of executing P on \vec{I}. Let Execs(P) be the set of such executions generated by all possible \vec{I}. By viewing each statement as a node, Execs(P) advantageously forms a tree, which will be referred to herein as the “execution tree.” Note that the tree's assignment nodes have one successor, its conditional nodes have one or two successors, and its leaves are labeled abort or halt.

In accordance with the illustrative embodiment of the present invention, the goal of DART (as described herein) is to explore all paths in the execution tree Execs(P). To simplify the following discussion, it will be assumed that we are given a theorem prover that decides, for example, the theory of integer linear constraints. (This is conventional and will be fully understood by one of ordinary skill in the art.) This will allow us to explain how we handle the transition from constraints within the theory to those that are outside.

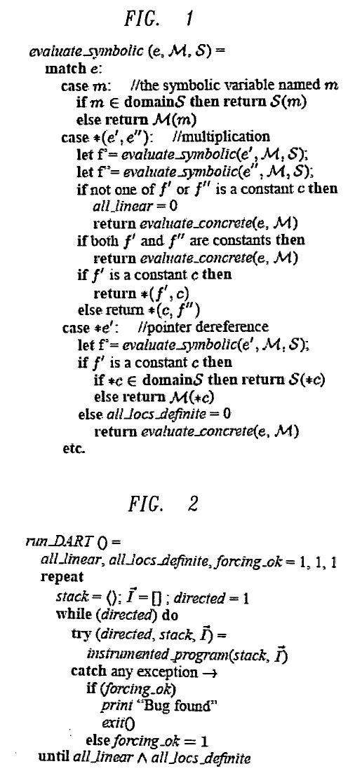

In accordance with the illustrative embodiment of the present invention, DART advantageously maintains a “symbolic memory” S that maps memory addresses to expressions. Initially, S is a mapping that maps each mε\vec{M}₀ to itself. Expressions are evaluated symbolically as described in FIG. 1. Specifically, FIG. 1 shows an illustrative “symbolic evaluation” routine for use in accordance with an illustrative embodiment of the present invention. In particular, when an expression falls outside the theory, as in the multiplication of two non-constant sub-expressions, DART advantageously falls back on the concrete value of the expression, which is used as the result. In such a case, we also advantageously set a flag all_linear equal to 0, which we use to track completeness. Another case where DART's directed search may be incomplete is when the program dereferences a pointer whose value depends on some input parameter; in this case, the flag all_locs_definite is advantageously set equal to 0 and the evaluation falls back again to the concrete value of the expression. With this evaluation strategy, symbolic variables of expressions in S are always advantageously contained in \vec{M}₀.

To carry out a search through the execution tree, the instrumented program may be run repeatedly. Each run (except for the first) is advantageously executed with the help of a record of the conditional statements executed in the previous run. For each conditional, a branch value is recorded, which value is either a 1 (if the then branch is taken) or a 0 (if the else branch is taken). In addition, a done value is also recorded, which value is a 0 when only one branch of the conditional has executed in prior runs (with the same history up to the branch point), and is a 1 otherwise. This information associated with each conditional statement of the last execution path is advantageously stored in a list variable called stack, which is advantageously kept in a file between executions. For i, 0≦i<|stack|, stack[i]=(stack[i].branch, stack[i].done) is the record corresponding to the i+1'st conditional executed.

FIG. 2 shows an illustrative “test driver” routine for use in accordance with an illustrative embodiment of the present invention. In particular, the test driver run_DART advantageously combines random testing (the repeat loop) with directed search (the while loop). If the instrumented program throws an exception, then a bug has been found. The two “completeness flags,” namely all_linear and all_locs_definite, each holds unless a “bad” situation possibly leading to incompletenes has occurred. Thus, if the directed search terminates—that is, if directed of the inner loop no longer holds—then the outer loop also terminates provided all of the completeness flags still hold. In this case, DART advantageously terminates and safely reports that all feasible program paths have been explored. If, on the other hand, even just one of the completeness flags have been turned off at some point, then the outer loop continues forever.

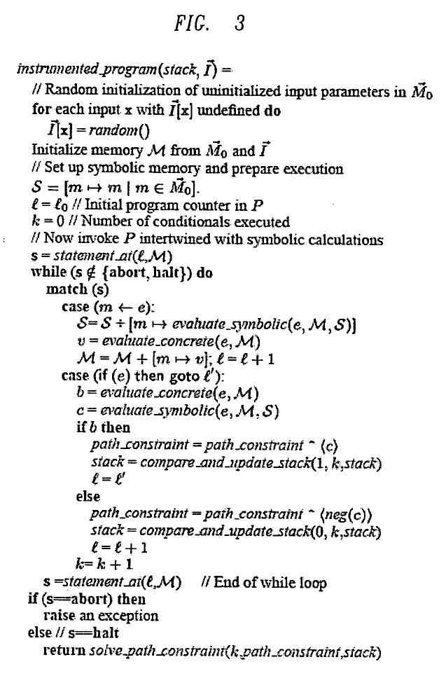

FIG. 3 shows an illustrative “instrumented program” routine for use in accordance with an illustrative embodiment of the present invention. (Note that the operator ˆ is used herein to denote list concatenation.) The instrumented program of FIG. 3 advantageously executes as the original program, but with interleaved gathering of symbolic constraints.

FIG. 4 shows an illustrative “compare and update stack” routine for use in accordance with an illustrative embodiment of the present invention. At each conditional statement, the instrumented program of FIG. 3 advantageously calls compare_and_update_stack (as shown in FIG. 4), to check whether the current execution path matches the one predicted at the end of the previous execution and represented in stack passed between runs. Specifically, the illustrative embodiment described herein advantageously maintains the invariant that when instrumented_program is called, stack[|stack|−1].done=0 holds. This value is changed to 1 if the execution proceeds according to all the branches in stack as checked by compare_and_update_stack. If it ever happens that a prediction of the outcome of a conditional is not fulfilled, then the flag forcing_{‘}ok is advantageously set to 0 and an exception is raised to restart run_DART with a fresh random input vector.

Note that setting forcing_ok to 0 can only be due to a previous incompleteness in DART's directed search, which was then (conservatively) detected and resulted in setting (at least) one of the completeness flags to 0. In other words, the following invariant always holds: all_linear Λ all_locs_definite=>forcing_ok.

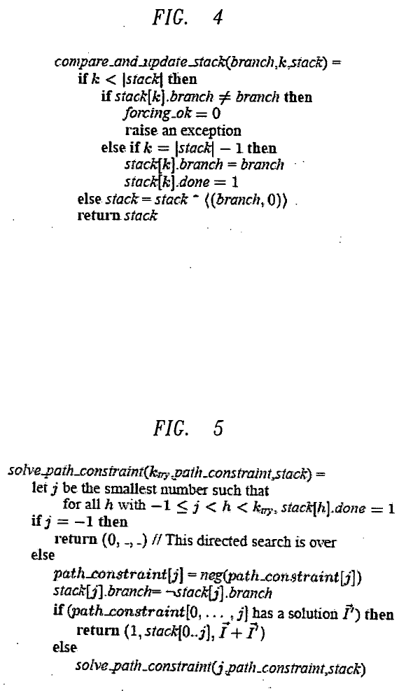

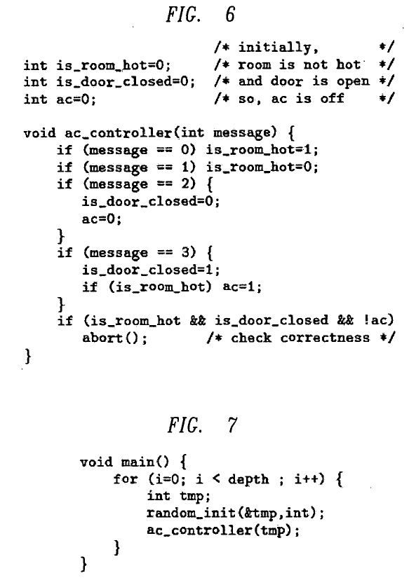

FIG. 5 shows an illustrative “solve path constraint” routine for use in accordance with an illustrative embodiment of the present invention. When the original program halts, new input values are generated in solve_path_constraint (as shown in FIG. 5), to attempt to force the next run to execute the last unexplored branch of a conditional along the stack. (Note that a depth first search is advantageously used for exposition, but the next branch to be forced could, in accordance with other illustrative embodiments of the present invention, be selected using a different strategy such as, for example, randomly or in a breadth first manner.) If such a branch exists and if the path constraint that may lead to its execution has a solution \vec{I}′, this solution is used to update the mapping \vec{I} to be used for the next run. Values corresponding to input parameters not involved in the path constraint are advantageously preserved. (This update is denoted \vec{I}+\vec{I}′.)

Note that the illustrative embodiment of the present invention described herein advantageously provides a method of performing unit testing of software modules which is both sound (with respect to errors found) and complete. Specifically, given run_DART executed on a program P as defined above, then (a) if run_DART prints out “Bug found′” for P, then there is some input to P that leads to an abort; (b) if run_DART terminates without printing “Bug found,” then there is no input that leads to an abort statement in P, and all paths in Execs(P) have been exercised; and (c) otherwise, run_DART will run forever. Note in particular that the accuracy of assertion (b) above rests on the assumption that any potential incompleteness in DART's directed search is (conservatively) detected and recorded by setting at least one of the two flags all_linear and all_locs_definite to 0.

Since, in accordance with the illustrative embodiment of the present invention described herein, DART performs (typically partial) symbolic executions only as generalizations of concrete executions, a key difference between DART and conventional static analysis based approaches to software verification is that any error found by DART is assured to be sound (as pointed out in assertion (a) above), even when using an incomplete or wrong theory. In accordance with other illustrative embodiments of the present invention, the chances of termination in assertion (b) above may be advantageously maximized by setting off completeness flags as described above in evaluate_symbolic (see FIG. 1) in a less conservative manner (i.e., more accurately) by using various optimization techniques, such as, for example, by distinguishing incompleteness in expressions used in (perhaps harmless) assignments from those used in conditional statements, by refining after each conditional statement the constraints stored in the symbolic memory S and associated with symbolic variables involved in the conditional, by dealing with pointer dereferences in a more sophisticated way, or by using other techniques that will be obvious to those of ordinary skill in the art.

Consider the following C program:

int f(int x, int y) {

int z;
z = y;
if (x == z)

if (y == x + 10)

abort( );

return 0;

}

The input address vector is \vec{M}₀=<mₓ, m_{y}> (where mₓ≠m_{y} are some memory addresses) for f's input parameters <x, y>. Assume that the first value for x is 123456 and that of y is 654321—that is, \vec{I}=<123456, 654321>. Then, the initial concrete memory becomes M=[mₓ [symbol] 123456, m_{y} [symbol] 654321], and the initial symbolic memory becomes S=[mₓ [symbol] mₓ, m_{y} [symbol] m_{y}]. During execution from this configuration, the else branch of the outer if statement is advantageously taken, and, at the time halt is encountered, the path constraint is < [symbol] (mₓ=m_{y})>. Then, we advantageously have k=1, stack=<(0,0)>, S=[mₓ [symbol] mₓ, m_{y} [symbol] m_{y}, m_{z} [symbol] m_{y}], and M=[mₓ [symbol] 123456, m_{y} [symbol] 654321, m_{z} [symbol] 654321]. The subsequent call to solve_path_constraint results in an attempt to solve <(mₓ=m_{y})>, which advantageously leads to a solution <mₓ [symbol] 0, m_{y} [symbol] 0>. The updated input vector \vec{I}+\vec{I}′ is then <0, 0>, the branch bit in stack has been advantageously flipped, and the assignment (directed, stack, \vec{I})=(1, <(1,0)>, <0,0>) is executed in run_DART.

During the second call of instrumented_program, compare_and_update_stack will advantageously check that the actually executed branch of the outer if statement is now the then branch, which it is. Next, the else branch of the inner if statement is executed. Consequently, the path constraint that is now to be solved is <mₓ=m_{y}, m_{y}=mₓ+10>. The run_DART driver then calls solve_path_constraint with (k_{try}, path_constraint, stack)=(2, <mₓ=m_{y}, m_{y}=mₓ+10>, <(1,1), (0,0)>). Since this path constraint has no solution, and since the first conditional has already been covered (i.e., stack[0].done=1), solve_path_constraint advantageously returns (0,_,_). In turn, run_DART terminates, since all completeness flags are still set.

Despite an inherent limited completeness of DART when based on linear integer constraints, dynamic analysis often has a well known advantage over static analysis when reasoning about dynamic data. For example, to determine if two pointers point to the same memory location, DART, in accordance with the illustrative embodiment of the present invention described herein, simply checks whether their values are equal and does not require alias analysis.

Consider the following C program:

struct foo { int i; char c; }
bar (struct foo *a) {

if (a−>c == 0) {

*((char *)a + sizeof(int)) = 1;
if (a−>c != 0) {

abort( ); }}}

DART here treats the pointer input parameter by randomly initializing it to NULL or to a single heap-allocated cell of the appropriate type (see above). For this example, a static analysis will typically not be able to report with high certainty that abort ( ) is reachable. Sound conventional static analysis tools will report that “the abort might be reachable,” and unsound ones will simply report “no bug found”, because standard alias analysis is not able to guarantee that a→c has been overwritten. In contrast, DART advantageously finds a precise execution leading to the abort by simply generating an input satisfying the linear constraint a→c==0. Note that this kind of code is often found in implementations of network protocols, where a buffer of type char* (e.g., representing a message) is occasionally cast into a struct (e.g., representing the different fields of the protocol encoded in the message) and vice versa.

The DART approach of intertwined concrete and symbolic execution in accordance with the illustrative embodiment of the present invention described herein has at least two important advantages over prior art techniques. First, any execution leading to an error detected by DART is (trivially) sound. Second, limitations of the constraint solver (i.e., the theorem prover) are advantageously alleviated. In particular, whenever DART generates a symbolic condition at a branching statement while executing the program under test, and the theorem prover cannot decide whether that symbolic condition is true or false, this symbolic condition is simply replaced by its concrete value—namely, either true or false. This advantageously allows DART to continue both the concrete and symbolic execution in spite of the limitation of the theorem prover. Note that conventional static analysis tools using predicate abstraction will typically consider both branches from that branching point, which may result in unsound behaviors. A test generation tool using symbolic execution, on the other hand, will stop its symbolic execution at that point and may miss bugs appearing down the branch.

To illustrate the above point, consider the following C program:

| | |
|---|---|
| 1 | foobar(int x, int y){ |

| | |
|---|---|
| 2 | if (x*x*x > 0){ |

| | |
|---|---|
| 3 | if (x>0 && y==10){ |

| | |
|---|---|
| 4 | abort( ); |

| | |
|---|---|
| 5 | } |

| | |
|---|---|
| 6 | } else { |

| | |
|---|---|
| 7 | if (x>0 && y==20){ |

| | |
|---|---|
| 8 | abort( ); |

| | |
|---|---|
| 9 | } |

| | |
|---|---|
| 10 | } |

| | |
|---|---|
| 11 | } |

Given a theorem prover that cannot reason about nonlinear arithmetic constraints, a conventional static analysis tool using predicate abstraction will report that both aborts in the above code are reachable, hence giving one false alarm since the abort in line 8 is, in fact, unreachable. Note that this would be true as well if the test (x*x*x>0) were replaced by a library call or if it were dependent on a configuration parameter read from a file.

On the other hand, a conventional test generation tool based on symbolic execution will not be able to generate an input vector to detect any abort because its symbolic execution will be stuck at the branching point in line 2. In contrast, DART, in accordance with the illustrative embodiment of the present invention described herein, can randomly generate an input vector where x>0 and y!=10 with almost 0.5 probability. Then, after the first execution with such an input, the directed search of DART will advantageously generate another input with the same positive value of x but with y==10, which will lead the program in its second run to the abort at line 4. Note also that if DART randomly generates a negative value for x in the first run, then DART will generate in the next run inputs where x>0 and y==20 to satisfy the other branch at line 7. (Note that it will do so because no constraint is generated for the branching statement in line 2 since it is nonlinear.) However, due to the concrete execution, DART will then not take the else branch at line 6 in such a second run. In summary, the mixed strategy of random and directed search along with simultaneous concrete and symbolic execution of the program will advantageously allow us to find the only reachable abort statement in the above example with high probability.

In accordance with one illustrative embodiment of the present invention, the above described algorithms may be specifically adopted for testing programs written in the C programming language. First, given a program to test, in accordance with this illustrative embodiment of the present invention, DART advantageously identifies the external interfaces through which the program can obtain inputs via uninitialized memory locations \vec{M}₀. In the context of C, we define the external interfaces of a C program as (a) its external variables and external functions (reported as “undefined reference” at the time of compilation of the program), and (b) the arguments of a user-specified “toplevel function,” which is a function of the program called to start its execution.

An advantage of this definition is that the external interfaces of a C program can be easily determined and instrumented by a lightweight static parsing of the program's source code. Inputs to a C program are advantageously defined as memory locations which are dynamically initialized at runtime through the static external interface. This allows us to handle inputs which are dynamic in nature, such as, for example, lists and trees, in a uniform way. Considering inputs as uninitialized runtime memory locations, instead of syntactic objects exclusively such as program variables, also allows us to advantageously avoid expensive or imprecise alias analyses, which form the basis of many conventional static analysis tools.

For each external interface, we advantageously determine the type of the input that can be passed to the program via that interface. As is well known to those of ordinary skill in the art, in C, a type is defined recursively as either a “basic type” such as, for example, “int,” “float,” “char” or “enum,” a “struct type” composed of one or more fields of other types, an array of another type, or a pointer to another type.

FIG. 6 shows an illustrative C code example to be tested with use of the herein described method for performing unit testing of software modules in accordance with an illustrative embodiment of the present invention. The illustrative C code shown in FIG. 6 simulates a controller for an air conditioning (AC) system. The toplevel function is ac_controller, and the external interface is simply its argument message, of basic type int.

Note that three kinds of C functions are distinguished herein:

1. “Program functions” are functions defined in the program.

2. “External functions” are functions controlled by the environment and hence part of the external interface of the program. Such functions can non-deterministically return any value of their specified return type.

3. “Library functions” are functions not defined in the program but controlled by the program, and hence considered as part of it. Examples of such functions are operating system functions and functions defined in the standard C library. These functions are advantageously treated as unknown but deterministic “black boxes” which we cannot instrument or analyze.

Note that the ability of DART, in accordance with the illustrative embodiment of the present invention described herein, to handle deterministic but unknown (and arbitrarily complex) library functions by simply executing these makes it unique compared to conventional symbolic execution based frameworks, as discussed above. In practice, a DART user can advantageously adjust the boundary between library and external functions to simulate desired effects. For example, errors in system calls can easily be simulated by considering the corresponding system functions as external functions instead of library functions.

Once the external interfaces of the C program are identified, DART, in accordance with the illustrative embodiment of the present invention, next generates a nondeterministic/random test driver simulating the most general environment visible to the program at its interfaces. This test driver is itself a C program, which performs the random initialization abstractly described at the beginning of the function instrumented_program( ) as shown in FIG. 3 and described above, and which is advantageously defined as follows:

1. The test driver consists of a function main which initializes all external variables and all arguments of the toplevel function with random values by calling the function random_init (as defined below), and then calls the application's toplevel function. The user of DART specifies (using the parameter depth) the number of times the toplevel function is to be called iteratively in a single run.

2. The test driver also contains code simulating each external function in such a way that whenever an external function is called during the program execution, a random value of the function's return type is returned by the simulated function.

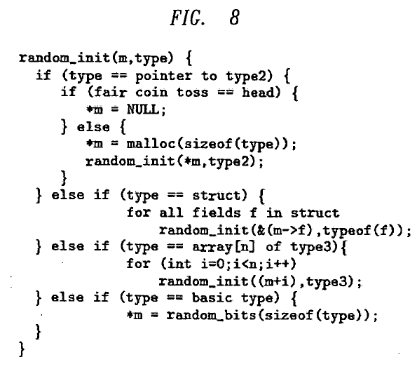

FIG. 7 shows an illustrative test driver generated for the illustrative C code example of FIG. 6 (i.e., the AC controller) in accordance with an illustrative embodiment of the present invention.

FIG. 8 shows an illustrative procedure for randomly initializing C variables for use in accordance with an illustrative embodiment of the present invention. Specifically, this procedure (random_init) performs the initialization of memory locations controlled by the external interface, taking as arguments a memory location m and the type of the value (type) to be stored at nm, and initializes randomly the location m depending on its type. If m stores a value of basic type, its value *m is initialized with the auxiliary procedure random_bits, which returns n random bits where n is its argument. (As is fully familiar to those of ordinary skill in the art, in C, *m denotes the value stored at m.) If, on the other hand, its type is a pointer, the value of location m is randomly initialized with either the value NULL (with a 0.5 probability) or with the address of a newly allocated memory location, whose value is in turn initialized according to its type following the same recursive rules. Finally, if its type is a struct or an array, every sub-element is initialized recursively in the same manner. Note that when inputs are data structures defined with a recursive type (such as, for example, lists), this general procedure can thus generate data structures of unbounded sizes.

For each external variable or argument to the toplevel function, such as, for example, v, DART, in accordance with the illustrative embodiment of the present invention described herein, generates a call to random_init (&v, typeof (v)) in the function main of the test driver before calling the toplevel function. For example, in the case of the illustrative AC controller program, the variable message forming the external interface is of type int, and therefore the corresponding initialization code random_init (&tmp, int) is generated. (See FIG. 7.) (As is fully familiar to those of ordinary skill in the art, in C, &v gives the memory location of the variable v.)

Similarly, if the C program being tested can call an external function, such as, for example, return_type some_fun( ), then the test driver generated by DART in accordance with the illustrative embodiment of the present invention will include a definition for this function, which, illustratively, may be as follows:

return_type some_fun( ){

return_type tmp;
random_init(&tmp,return_type);
return tmp;

}

Once the test driver has been generated, it can be advantageously combined with the C program being tested to form a “self-executable” program, which can be advantageously compiled and executed automatically.

In accordance with the illustrative embodiment of the present invention described herein, a directed search is advantageously implemented using a dynamic instrumentation as explained above. Note, however, that when dealing with C in particular, all the possible types that C allows should be advantageously handled, and symbolic constraints should be advantageously generated and manipulated, especially across function boundaries (i.e., tracking inputs through function calls when a variable whose value depends on an input is passed as argument to another program function).

In accordance with the illustrative embodiment of the present invention described herein, the code instrumentation needed to intertwine the concrete execution of the program P with the symbolic calculations performed by DART as described above in the function instrumented_program( ) (see FIG. 3) may be advantageously performed using a conventional application for parsing and analyzing C code. (See, for example, G. C. Necula et al., “CIL: Intermediate Language and Tools for Analysis and Transformation of C Programs,” Proceedings of Conference on Compiler Construction, pp. 213-218, 2002.) Similarly, in accordance with the illustrative embodiment of the present invention described herein, any conventional constraint solver which can solve linear constraints using, for example, real and integer programming techniques, may be used. (Linear constraint solvers using real and integer programming techniques are fully familiar to those of ordinary skill in the art.)

For the sake of modeling “realistic” external environments, it has been assumed herein that the execution of external functions do not have any side effects on (i.e., do not change the value of) any previously defined stack or heap allocated program variable, including those passed as arguments to the function. For example, it is assumed that an external function returning a pointer to an int can only return NULL or a pointer to a newly allocated int, not a pointer to a previously allocated int. Note that this assumption does not restrict generality—external functions with side effects or returning previously defined heap allocated objects can be advantageously simulated by adding interface code between the program and its environment. (Such a modification will be obvious to those of ordinary skill in the art.)

Another assumption made herein is that all program variables (i.e., all those not controlled by the environment) are properly initialized. Detecting uninitialized program variables can be done using other, conventional, analyzers and tools, either statically or dynamically or both. (Such tools will also be fully familiar to those of ordinary skill in the art.)

Finally, note that rather than using a static definition of interface for C programs as described herein, in accordance with other illustrative embodiments of the present invention, a dynamic definition may be used, such as, for example, considering any uninitialized variable (i.e., memory location) read by the program as an input. (Note that, in general, detecting inputs with such a loose definition is best done dynamically, using a dynamic program instrumentation similar to one for detecting uninitialized variables.)

Addendum to the Detailed Description

It should be noted that all of the preceding discussion merely illustrates the general principles of the invention. It will be appreciated that those skilled in the art will be able to devise various other arrangements, which, although not explicitly described or shown herein, embody the principles of the invention, and are included within its spirit and scope. In addition, all examples and conditional language recited herein are principally intended expressly to be only for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. It is also intended that such equivalents include both currently known equivalents as well as equivalents developed in the future—i.e., any elements developed that perform the same function, regardless of structure.

We claim:

1. An automated computer-implemented method for performing unit testing of a software module, the software module comprising an external interface comprising one or more input variables having unknown values, the software module further comprising a plurality of possible program execution paths which may result from an execution of said software module, each of said program execution paths comprising one or more outcomes of one or more of said conditional expressions comprised in said software module, the method comprising the steps of:
(a) performing static source code parsing of said software module to identify said one or more input variables of said external interface;
(b) generating a test driver for said software module, said test driver comprising software code which effectuates at least an initial execution of said software module with a set of one or more arbitrary values assigned to corresponding ones of said one or more input variables;
(c) executing said test driver for said software module and automatically determining from said execution thereof an initial one of said program execution paths of said software module which results therefrom; and
(d) generating a new set of values to be assigned to corresponding ones of said one or more input variables based on said determined initial program execution path, such that when an execution of said test driver effectuates a subsequent execution of said software module with said new set of values having been assigned to said corresponding ones of said one or more input variables, said subsequent execution of said software module will result in an alternative one of said program execution paths, said alternative program execution path comprising at least one outcome of one of said corresponding conditional expressions comprised in said software module which differs from the outcome of the corresponding conditional expression comprised in said initial program execution path.

2. The method of claim 1 further comprising the step of:
(e) iteratively repeating steps (c) and (d) of said method until each of said possible program execution paths of said software module results from one of said executions of said test driver of said software module performed in one of said iterative repetitions of step (c).

3. The method of claim 2 wherein said set of one or more arbitrary values assigned to corresponding ones of said one or more input variables are determined with use of a random value generation technique.

4. The method of claim 2 wherein the step of iteratively repeating steps (c) and (d) comprises using a stack representative of said program execution paths and said outcomes of said conditional expressions.

5. The method of claim 3 wherein the step of iteratively repeating steps (c) and (d) comprises using said stack to perform a depth first search of said possible program execution paths of said software module.

6. The method of claim 2 further comprising the step of generating an instrumented version of said software module, said instrumented version of said software module comprising a RAM machine version thereof, and wherein said execution of said test driver effectuates said initial execution of said software module and said subsequent executions of said software module by executing said instrumented version of said software module.

7. The method of claim 6 wherein the step of generating a new set of values to be assigned to corresponding ones of said one or more input variables comprises generating a symbolic representation of one or more program execution paths, said symbolic representations comprising one or more symbolic variables representative of corresponding program variables in said software module.

8. The method of claim 7 wherein each of said symbolic variables has an associated memory address during said execution of said instrumented version of said software module, and wherein said symbolic variables are identified by said associated memory addresses.

9. The method of claim 2 wherein said one or more input variables having unknown values comprise one or more values to be returned by one or more external functions.

10. A computer-readable medium having recorded thereon a software program to be executed on a computer, the software program for performing unit testing of a software module, the software module comprising an external interface comprising one or more input variables having unknown values, the software module further comprising a plurality of possible program execution paths which may result from an execution of said software module, each of said program execution paths comprising one or more outcomes of one or more of said conditional expressions comprised in said software module, the software program implementing the program steps of:
(a) performing static source code parsing of said software module to identify said one or more input variables of said external interface;
(b) generating a test driver for said software module, said test driver comprising software code which effectuates at least an initial execution of said software module with a set of one or more arbitrary values assigned to corresponding ones of said one or more input variables;
(c) executing said test driver for said software module and automatically determining from said execution thereof an initial one of said program execution paths of said software module which results therefrom; and
(d) generating a new set of values to be assigned to corresponding ones of said one or more input variables based on said determined initial program execution path, such that when an execution of said test driver effectuates a subsequent execution of said software module with said new set of values having been assigned to said corresponding ones of said one or more input variables, said subsequent execution of said software module will result in an alternative one of said program execution paths, said alternative program execution path comprising at least one outcome of one of said corresponding conditional expressions comprised in said software module which differs from the outcome of the corresponding conditional expression comprised in said initial program execution path.

11. The computer-readable medium of claim 10 wherein the software program further implements the program step of:
(e) iteratively repeating program steps (c) and (d) implemented by said software program until each of said possible program execution paths of said software module results from one of said executions of said test driver of said software module performed in one of said iterative repetitions of program step (c).

12. The computer-readable medium of claim 10 wherein said set of one or more arbitrary values assigned to corresponding ones of said one or more input variables are determined with use of a random value generation technique.

13. The computer-readable medium of claim 11 wherein the program step of iteratively repeating steps (c) and (d) comprises using a stack representative of said program execution paths and said outcomes of said conditional expressions.

14. The computer-readable medium of claim 12 wherein the program step of iteratively repeating steps (c) and (d) comprises using said stack to perform a depth first search of said possible program execution paths of said software module.

15. The computer-readable medium of claim 11 wherein the software program further implements the program step of generating an instrumented version of said software module, said instrumented version of said software module comprising a RAM machine version thereof, and wherein said execution of said test driver effectuates said initial execution of said software module and said subsequent executions of said software module by executing said instrumented version of said software module.

16. The computer-readable medium of claim 15 wherein the program step of generating a new set of values to be assigned to corresponding ones of said one or more input variables comprises generating a symbolic representation of one or more program execution paths, said symbolic representations comprising one or more symbolic variables representative of corresponding program variables in said software module.

17. The computer-readable medium of claim 16 wherein each of said symbolic variables has an associated memory address during said execution of said instrumented version of said software module, and wherein said symbolic variables are identified by said associated memory addresses.

18. The computer readable medium of claim 11 wherein said one or more input variables having unknown values comprise one or more values to be returned by one or more external functions.

19. An apparatus comprising:
a processor; and
a memory, the memory comprising therein a software program to be executed on said processor, the software program for performing unit testing of a software module, the software module comprising an external interface comprising one or more input variables having unknown values, the software module further comprising a plurality of possible program execution paths which may result from an execution of said software module, each of said program execution paths comprising one or more outcomes of one or more of said conditional expressions comprised in said software module, the software program implementing the program steps of:
(a) performing static source code parsing of said software module to identify said one or more input variables of said external interface;
(b) generating a test driver for said software module, said test driver comprising software code which effectuates at least an initial execution of said software module with a set of one or more arbitrary values assigned to corresponding ones of said one or more input variables;
(c) executing said test driver for said software module and automatically determining from said execution thereof an initial one of said program execution paths of said software module which results therefrom; and
(d) generating a new set of values to be assigned to corresponding ones of said one or more input variables based on said determined initial program execution path, such that when an execution of said test driver effectuates a subsequent execution of said software module with said new set of values having been assigned to said corresponding ones of said one or more input variables, said subsequent execution of said software module will result in an alternative one of said program execution paths, said alternative program execution path comprising at least one outcome of one of said corresponding conditional expressions comprised in said software module which differs from the outcome of the corresponding conditional expression comprised in said initial program execution path.

20. The apparatus of claim 19 wherein the software program further implements the program step of:
(e) iteratively repeating program steps (c) and (d) implemented by said software program until each of said possible program execution paths of said software module results from one of said executions of said test driver of said software module performed in one of said iterative repetitions of program step (c).

21. The apparatus of claim 19 wherein said set of one or more arbitrary values assigned to corresponding ones of said one or more input variables are determined with use of a random value generation technique.

22. The apparatus of claim 20 wherein the program step of iteratively repeating steps (c) and (d) comprises using a stack representative of said program execution paths and said outcomes of said conditional expressions.

23. The apparatus of claim 21 wherein the program step of iteratively repeating steps (c) and (d) comprises using said stack to perform a depth first search of said possible program execution paths of said software module.

24. The apparatus of claim 20 wherein the software program further implements the program step of generating an instrumented version of said software module, said instrumented version of said software module comprising a RAM machine version thereof, and wherein said execution of said test driver effectuates said initial execution of said software module and said subsequent executions of said software module by executing said instrumented version of said software module.

25. The apparatus of claim 24 wherein the program step of generating a new set of values to be assigned to corresponding ones of said one or more input variables comprises generating a symbolic representation of one or more program execution paths, said symbolic representations comprising one or more symbolic variables representative of corresponding program variables in said software module.

26. The apparatus of claim 25 wherein each of said symbolic variables has an associated memory address during said execution of said instrumented version of said software module, and wherein said symbolic variables are identified by said associated memory addresses.

27. The apparatus of claim 20 wherein said one or more input variables having unknown values comprise one or more values to be returned by one or more external functions.
